(19) United States
(12) Patent Application Publication
(10) Pub. No.: US 2010/0064106 A1
(43) Pub. Date: Mar. 11, 2010

(54) DATA PROCESSOR AND DATA PROCESSING SYSTEM

(75) Inventors: Tetsuya YAMADA, Sagamihara (JP); Naoki KATO, Kodaira (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/546,672

(22) Filed: Aug. 24, 2009

(30) Foreign Application Priority Data
Sep. 9, 2008 (JP) 2008-231147

(51) Int. Cl. G06F 9/38; G06F 12/08

(52) U.S. Cl. 711/125; 712/240; 712/234; 712/241; 712/E09.045; 711/E12.017

(57) ABSTRACT

The present invention provides a data processor capable of automatically discriminating a loop program and performing a reduction in power by size-variable lock control on an instruction buffer. The instruction buffer of the data processor includes a buffer controller for controlling a memory unit that stores each fetched instruction therein. When an execution history of a fetched condition branch instruction suggests condition establishment, and in the case that the branch direction of the fetched condition branch instruction is a direction opposite to the order of an instruction execution and the difference of instruction addresses from the branch source to the branch target based on the condition branch instruction is a range held in the storage capacity of the instruction buffer, the buffer controller retains an instruction sequence from a branch source to a branch target based on the condition branch instruction in the instruction buffer. While the instruction execution of the instruction sequence retained therein is repeated, the buffer controller supplies the corresponding instruction of the instruction sequence from the instruction buffer to the instruction decoder and releases retention of the instruction sequence when the instruction execution is exited from the instruction sequence.

### CLAIM OF PRIORITY

The present application claims priority from Japanese application JP 2008-231147 filed on Sep. 9, 2008, the content of which is hereby incorporated by reference into this application.

### FIELD OF THE INVENTION

The present invention relates to a data processor and a data processing system that execute instructions. The present invention relates to, for example, a technology effective if applied to low power consumption of a microcomputer brought into semiconductor integrated circuitry, which is formed with a short loop based on a condition branch instruction.

### BACKGROUND OF THE INVENTION

When a CPU or a plurality of peripheral modules are mounted onto one SoC (System on Chip), the CPU might use a for-loop for performing a queuing process using a small loop program called spin loop used in process queuing or the like of a peripheral module, and a repetition process. Even in the case of a multicore equipped with a plurality of CPUs, a task with its own process being ended might be software-implemented using a spin loop upon its synchronous control until other tasks are all completed. The spin loop and the for-loop (these loops also described simply as short loop) small in the number of instructions in the loop are generally large in power consumption because instruction cache access is repeatedly performed on each instruction in the loop during loop processing, and a loop's branch process is performed.

The CPU stores each instruction held in a cache memory or a ROM in an instruction fetch section and supplies the same to a decode unit. The instruction fetch section comprises an instruction queue and an instruction fetch controller for controlling the instruction queue. As a reduction in power of the instruction fetch section, there is known a lock of the instruction queue, for holding an instruction in the instruction queue and inhibiting instruction access to the cache memory.

In order to fix or define a location to lock the instruction queue at the loop program, there is known a method of embedding an instruction for controlling the instruction queue in its corresponding program as described in an embodiment 1 of a patent document 1 (WO98-36351). A register for instruction queue control is prepared and a value is set to the register by a control instruction, whereby control on the instruction queue can be specified by software. It is necessary to add an instruction queue control instruction to software free of execution of the instruction queue control. While an example illustrative of a repeat instruction and repeat registers (start, end and counter) used in DSP is shown in an embodiment 3 of the patent document 1, a repeat instruction's code for the instruction queue control is embedded during program in a manner similar to the embodiment 1.

As means for automatically discriminating the location of a loop program by hardware and locking an instruction queue without adding the code for the instruction queue control, a method using a branch target cache corresponding to one of branch predictions or expectations is known as shown in a patent document 2. The branch target cache is of means for holding an address for a branch instruction, an address for a branch target and history information about past branches and predicting a branch. The reason why the branch prediction is used will be explained. When the instruction queue is locked, the use of the instruction queue is limited. Therefore, since it influences the original lookahead effect of the instruction queue, it is desired that the probability of the loop being executed is raised. When the branch target cache is used, it is understood by the address of the branch target and the branch prediction whether the branch should be performed. Therefore, the location of the loop and whether the loop should be done can be discriminated. Thus, the instruction queue is locked in combination with the branch prediction. The patent document 2 provides a method for locking an instruction queue when a branch instruction and a branch target instruction are contained in one or two predetermined instruction lines containing a plurality of instructions, using information in the branch target cache.
Patent document 1: WO98-36351
Patent document 2: Japanese unexamined Patent Publication No. Hei 8 (1996)-77000

### SUMMARY OF THE INVENTION

Upon implementation of the reduction in power of CPU at the loop program, the two known examples have been cited depending on whether a change in program is made. The patent document 1 is accompanied with the change in program, whereas the patent document 2 is not accompanied with the change in program. Considering the convenience of a user, the change in program may not preferably be made in that the existing software can be used. The present inventors have investigated a mechanism for automatically discriminating a loop program by addition of small-sized software without the change in program and thereby performing a reduction in power. In the patent document 2, the loop program is automatically discriminated using the branch target cache. The branch target cache is branch predicting means used in a highend CPU. Since the address for the branch target is held therein, the branch target cache is large in memory capacity.

An embedded microprocessor utilizes a branch history table for holding only branch's history information as branch predicting means to reduce its area. Generally, the branch history table differs from the branch target cache in that the address for each branch target is not retained and the type of branch is limited. The types of branches include a branch instruction for a PC relative address, which defines a branch target address, based on a relative address from a branch instruction, and a register indirect branch instruction with a register defined as a branch target address. The branch target cache is targeted even for both of the PC relative address branch instruction and the register indirect branch instruction. The branch history table is generally targeted only for the PC relative address branch instruction and adopted for a branch prediction mechanism of a small area.

In the patent document 2, a single branch having a forward direction (increase in address) and a backward direction (decrease in address) in one or two predetermined number of instruction lines including a plurality of instructions is shown as an instruction sequence targeted for instruction queue lock. The instruction queue lock targets preferably include as much instructions as possible in a range that they enter into the instruction queue. There is also a case where multiple branches such as the existence of loops in a loop exist. This is not taken into consideration in the patent document 2.

An object of the present invention is to provide a data processor capable of automatically discriminating a loop program and performing a reduction in power by size-variable lock control on an instruction buffer.

Another object of the present invention is to provide a data processor capable of performing a reduction in power by lock control of an instruction buffer in association with multiple branches.

The above and other objects and novel features of the present invention will become apparent from the description of the present specification and the accompanying drawings.

A typical one of the inventions disclosed in the present application will be explained in brief as follows:

An instruction buffer of a data processor includes a buffer controller for controlling a memory unit storing each fetched instruction. When an execution history of a fetched condition branch instruction suggests condition establishment, the buffer controller retains an instruction sequence from a branch source to a branch target based on the condition branch instruction in the memory unit when a branch direction of the fetched condition branch instruction corresponds to a direction opposite to the order of an instruction execution and a difference between instruction addresses from the branch source and the branch target based on the condition branch instruction is a range held in a storage capacity of the memory unit. The buffer controller supplies each instruction of the instruction sequence from the memory unit to an instruction decoder while an instruction execution of the instruction sequence retained therein is repeated, and releases retention of the instruction sequence when the instruction exits from the instruction execution of the instruction sequence. According to the above, the buffer controller is capable of automatically discriminating a loop program based on a condition branch instruction. The buffer controller holds each instruction of a loop from a branch source to a branch target based on a condition branch instruction in the range held in the storage capacity of the memory unit and is used in processing of the loop, thereby making it possible to perform size-variable lock control on the instruction buffer and contribute to the realization of a reduction in power.

For example, a branch counter indicative of a multiple number of loops each formed by the instruction sequence from the branch source and target based on the condition branch instruction is adopted in the buffer controller. When the loop is a single loop, the buffer controller holds each instruction of the loop on the memory unit in association with a branch target address and a branch source address of the single loop. When the loop is multiple loops, the buffer controller holds each instruction of the largest loop on the instruction buffer in association with a branch target address and a branch source address of the largest loop and manages the multiple loops using the branch counter. Consequently, lock control on the instruction buffer is made possible corresponding to multiple branches.

Advantageous effects obtained by a typical one of the inventions disclosed in the present application will be explained in brief as follows:

According to the present invention, a loop program can be discriminated automatically and a reduction in power by size-variable lock control on an instruction buffer can be performed.

According to the present invention as well, a reduction in power by lock control on the instruction buffer can be performed corresponding to multiple branches.

### BRIEF DESCRIPTION OF THE DRAWINGS

FIG. 1 is a block diagram illustrating a configuration of an instruction queue;

FIG. 2 is a block diagram showing one example of a data processor according to the present invention on an overall basis;

FIG. 3 is an explanatory diagram depicting an example of a short loop;

FIG. 4 is a state transition diagram showing one example of a branch prediction;

FIG. 5 is a block diagram illustrating conceptually a configuration of a branch prediction unit;

FIG. 6 is a block diagram illustrating a configuration of an instruction queue lock controller (LKCTL);

FIG. 7 is a flowchart illustrating a control operation of the instruction queue;

FIG. 8 is a block diagram showing another example of an instruction queue lock controller (LKCTL);

FIG. 9 is an explanatory diagram showing an example of a short loop including double branches;

FIG. 10 is a block diagram depicting a further example of an instruction queue lock controller;

FIG. 11 is a flowchart showing a multiple branch-based instruction queue lock control operation;

FIG. 12 is an explanatory diagram illustrating a first operation for multiple branch-based instruction queue lock control by the instruction queue lock controller shown in FIG. 10;

FIG. 13 is an explanatory diagram illustrating a second operation for multiple branch-based instruction queue lock control by the instruction queue lock controller shown in FIG. 10; and

FIG. 14 is an explanatory diagram illustrating a third operation for multiple branch-based instruction queue lock control by the instruction queue lock controller shown in FIG. 10.

### DETAILED DESCRIPTION OF THE PREFERRED EMBODIMENTS

1. Outline of Embodiments

Summary of typical embodiments of the invention disclosed in the present application will first be explained. Reference numerals of the accompanying drawings referred to with parentheses in the description of the summary of the typical embodiments only illustrate elements included in the concept of components to which the reference numerals are given.

[1] A data processor (1) according to the present invention comprises an instruction fetch section (20) for fetching an instruction, an instruction decoder (21) for decoding the instruction fetched by the instruction fetch section, and an executor (22) for executing the instruction, based on the result of decoding by the instruction decoder. The instruction fetch section includes an instruction buffer (26) and a branch prediction unit (25). The instruction buffer includes a memory unit (40) for storing each instruction fetched from outside and a buffer controller (44) for controlling the memory unit. When an execution history of a fetched condition branch instruction suggests condition establishment, and in the case that a branch direction of the fetched condition branch instruction corresponds to a direction opposite to the order of an instruction execution and a difference of instruction addresses from the branch source to the branch target based on the condition branch instruction is a range held in a storage capacity of the memory unit, the buffer controller retains in the memory unit an instruction sequence from a branch source to a branch target based on the condition branch instruction, supplies each instruction of the instruction sequence from the memory unit to the instruction decoder while an instruction execution of the instruction sequence retained therein is repeated, and releases retention of the instruction sequence when the instruction exits from the instruction execution of the instruction sequence.

[2] In the data processor as defined in the paragraph [1], the buffer controller performs control of a read pointer (read_ptr) and a write pointer (write_ptr) based on an FIFO form on the memory unit, specifies the instruction sequence retained in the memory unit by a lock start pointer (lcks_ptr) and a lock end pointer (lcke_ptr), and changes the read pointer in a range designated by the lock start pointer and the lock end pointer while the instruction execution of the instruction sequence is repeated.

[3] In the data processor as defined in the paragraph [2], the buffer controller performs pointer control using a branch control table in which an instruction address (BADR) for the condition branch instruction and in-buffer addresses (QBADR, QTADR) of the memory unit holding the condition branch instruction and a branch target instruction based thereon respectively are registered.

[4] In the data processor as defined in the paragraph [3], when each of condition branch instructions is contained in the instruction fetched into the memory unit, the buffer controller registers information about the instruction sequence of the condition branch instructions in the branch control table.

[5] In the data processor as defined in the paragraph [1], the condition branch instruction is a PC relative condition branch instruction.

[6] In the data processor as defined in the paragraph [1], the instruction fetch section has a branch prediction unit (25) for performing a branch prediction, based on the execution history of the condition branch instruction. The branch prediction unit performs a branch prediction, based on the instruction address for the condition branch instruction and outputs the result of prediction thereof. The buffer controller determines, based on the result of prediction, whether the condition establishment of the condition branch instruction is suggested.

[7] In the data processor as defined in the paragraph [1], the buffer controller has a branch history counter (85) for counting the number of repetitive executions of the instruction sequence from the branch source to the branch target based on the condition branch instruction with a branch direction being placed in an opposite direction. The buffer controller determines that the formation of a short loop is suggested, by a counted value of the branch history counter exceeding a predetermined value.

[8] In the data processor as defined in the paragraph [2], the buffer controller has a branch counter (86) indicative of a multiple number of loops each formed by the instruction sequence from the branch source and target based on the condition branch instruction. When the loop is a single loop, the buffer controller determines the values of the lock start pointer and the lock end pointer in association with a branch target address and a branch source address of the single loop. When the loop is multiple loops, the buffer controller determines the values of the lock start pointer and the lock end pointer in association with a branch target address and a branch source address of the largest loop.

[9] In the data processor as defined in the paragraph [2], the buffer controller acquires, every loop, first data (x) corresponding to a difference in address of a read pointer relative to the branch source on the memory unit, second data (y) corresponding to a difference in address of a branch target relative to a read pointer on the memory unit and third data (x+y) corresponding to the sum of the first data and the second data. The buffer controller determines, by assuming the first and second data to be positive integer values respectively, whether the corresponding read pointer is within its own loop, discriminates comprehensive relationships of the branch sources in the multiple loops, based on the magnitude of the first data for each loop, and discriminates a relationship between the magnitudes of the loops in the multiple loops, based on the magnitude of the third data for each loop.

[10] The data processor as defined in the paragraph [1] further includes an instruction cache memory (11). The instruction fetch section fetches a necessary instruction from the instruction cache memory.

[11] A data processing system comprises a data processor as defined in the paragraph [10], and an external memory (2) coupled to the data processor. The instruction cache memory holds some of instructions retained in the external memory to perform an associative memory operation.

2. Details of Embodiments

Preferred embodiments will be explained in further detail. Modes for carrying out the present invention will hereinafter be described in detail based on the accompanying drawings. Incidentally, elements each having the same function in all drawings for describing the modes for carrying out the invention are respectively identified by like reference numerals, and their repetitive explanations will therefore be omitted.

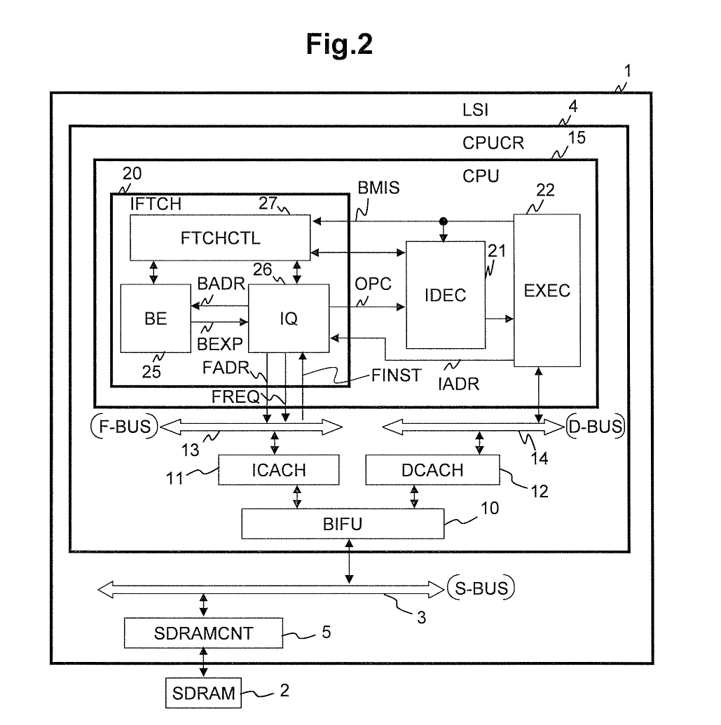

One example of a data processor according to the present invention is shown in FIG. 2. Although not limited in particular, the data processor (LSI) shown in the same figure is formed in one semiconductor substrate like monocrystal silicon by a CMOS integrated circuit manufacturing technology and configured as a semiconductor device of a system on chip (SoC), for example. A synchronous DRAM (SDRAM) 2 is coupled to the data processor 1 as an external storage device. The data processor 1 is equipped with a CPU core (CPUCR) 4 which shares a system bus (B-BUS) 3, a SDRAM controller 5 used as a memory controller, etc. The SDRAM controller 4 performs interface control for accessing the SDRAM 2 based on control of the CPU core 4.

In the CPU core 4, an instruction cache (ICACH) 11 and a data cache (DCACH) 12 are coupled to the system bus 3 via a bus interface unit (BIFU) 10. The instruction cache 11 is coupled to a central processing unit (CPU) 15 via an instruction fetch bus (F-BUS) 13 and the data cache 12 is coupled thereto via a data bus (D-BUS) 14. The CPU 15 comprises an instruction fetch section or fetcher (IFTCH) 20, an instruction decoder (IDEC) 21 and an executor (EXEC) 22. The instruction fetch section 20 comprises a branch prediction unit (BE) 25 which performs a branch prediction or expectation, an instruction buffer (IQ) 26 (hereinafter called also instruction queue for convenience) which holds an instruction from the instruction cache 11 and supplies it to the instruction decoder 21, and an instruction fetch controller (FTCHCTL) 27 which controls an instruction fetch. The instruction decoder 21 decodes an instruction outputted from the instruction queue 26. The executor 22 performs an address arithmetic operation on each operand, operand access to the data cache 12, a data arithmetic operation using each operand, etc. in accordance with the result of its decoding or the like thereby to execute an arithmetic instruction. Although not shown in the figure in particular, the executor 22 has an arithmetic unit, a general purpose register and a program counter or the like.

The CPU 15 processes an instruction in the following manner. An instruction address IADR set in accordance with the value of the program counter of the executor 22 is first supplied to the instruction queue 26. When an instruction corresponding to the instruction address IDAR does not exist within the instruction queue 26, a fetch request FREQ and a fetch address FADR are outputted from the instruction queue 26 to the instruction cache 11. When a necessary instruction does not exit on the instruction cache 11, the instruction cache 11 performs control for reading the necessary instruction from the SDRAM 2 through the SDRAM controller 5. Consequently, the necessary instruction is read into the instruction cache 11 through the bus interface unit 10 lying within the CPU core 15, which is coupled via the system bus 3. The instruction cache 11 supplies a fetch instruction FINST corresponding to an instruction sequence of plural words to the instruction queue 26 via the instruction fetch bus 13. The instruction queue 26 holds the instruction sequence supplied thereto and supplies an instruction (OPC: operation code) corresponding to the instruction address IADR to the instruction decoder 21. The instruction decoder 21 decodes the supplied instruction and the executor 22 controls processing specified by the instruction, e.g., processing such as an arithmetic operation, load/store of data, etc., based on the result of decoding thereof. Incidentally, when the instruction corresponding to the instruction address IADR exists within the instruction queue 26, the instruction lying within the instruction queue 26 is supplied directly to the instruction decoder 21. If the instruction corresponding to the instruction address IADR exists in the instruction cache 11 even though it does not exit within the instruction queue 26, then the corresponding instruction contained in the instruction cache 11 is supplied from the instruction queue 26 to the instruction decoder 21 without accessing the SDRAM 2.

Processing of the branch instruction will next be explained. The branch instruction includes a PC relative branch instruction which uses the value of the program counter (PC) for the purpose of determination of a branch target address, a register relative branch instruction which uses the value of the general purpose register for the purpose of determination of a branch target address, etc. In the case of a PC relative branch, a PC whose value is determined uniquely, may be used, whereas in the case of the register relative branch, the value of the register is not determined uniquely and often depends on the result of execution of the previous instruction or the like. Thus, it is advisable to use the PC relative branch for the purpose of avoiding taking time to determine a branch target. As the PC relative branch instruction, there are known, for example, condition branch instructions like “BT (PC+immediate value)” that sets the result of execution of the previous instruction as a branch condition for the return of a value of true, and “BF (PC+immediate value)” that sets the result of execution of the previous instruction as a branch condition for the return of a value of false. There is also known an unconditional branch instruction like “BRA (PC+immediate value)”. The branch target address at the PC relative branch instruction is determined by a value obtained by adding an immediate value contained in an instruction code to an instruction address (value of program counter PC) corresponding to a program position in the corresponding branch instruction.

Here, although not limited in particular, a target for branch prediction or expectation by the branch prediction unit 25 is assumed to be the PC relative branch instruction. When the instruction queue 26 detects through predecoding of an opcode that the PC relative branch instruction is contained in the instruction held by itself, it outputs a branch source address BADR corresponding to an instruction address of the PC relative branch instruction to the branch prediction unit 25. The branch prediction unit 25 performs a branch expectation and outputs the result of its expectation BEXP to the instruction queue 26. The instruction queue 26 performs the calculation of a branch target address by a PC relative branch, based on the PC relative branch instruction, branch source address BADR and branch expectation result BEXP and outputs the branch target address to the instruction cache 11 as a fetch address FADR. While a register indirect branch instruction is provided as the branch instruction except for the PC relative branch instruction, the register indirect branch instruction is subjected to an address calculation at the executor. Then, the result of calculation thereof is inputted to the instruction fetch section as an instruction address IADR. Thereafter, the instruction fetch section outputs a fetch address FADR to the instruction cache as a branch target address. The instruction cache 11 having received the branch target address supplies a fetch-target instruction (fetch instruction) FINST to the instruction cache 26 as a branch target instruction.

When a branch prediction miss is done, it is necessary to supply a proper instruction sequence to the instruction decoder 21. Its scheme will be explained. In the case of the branch prediction miss, the execution of an instruction sequence by the executor 22 is inhibited and at the same time a branch prediction miss signal BMIS is transmitted from the executor 22 to the fetch controller 27 of the instruction fetch section 20, where history information of the branch prediction unit 25 is updated. Along with it, the instruction cache 26 executes a necessary instruction fetch process using the proper instruction address IADR supplied from the executor 22.

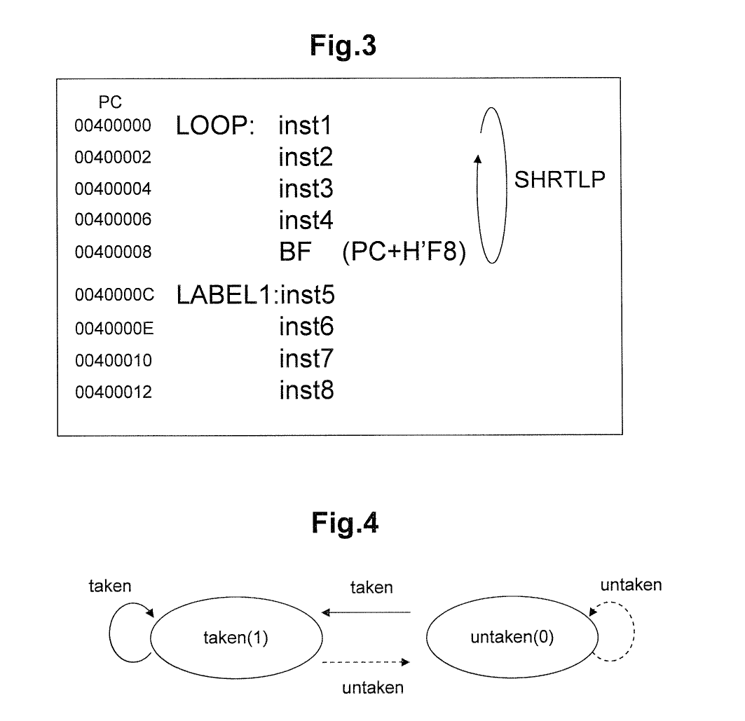

An example of a short loop is shown in FIG. 3. In the present specification, the term short loop (SHRTLP) names generically loops each taken as a repetitive instruction sequence small in the number of instructions, such as a spin loop, a for-loop, etc. In short, the small number of instructions means a range for the number of instructions storable in the instruction queue 26. A program counter (PC) and assembler representation are described in FIG. 3. An instruction 1 (inst1) to an instruction 8 (inst8) may be arbitrary instructions. A BF instruction is a PC relative branch instruction. Here, a branch target for the BF instruction assumes PC (H′ 00400008)+H′ F8 (most significant code)=H′00400008−H′ 8=H′ 00400000 (label LOOOP). Namely, the BF instruction is branched to the label LOOP and brought to a branch in the opposite direction in which an execution instruction address decreases. At this time, the instruction 1 (inst1) to BF instruction form a loop. The instructions that form the loop are small in number such as five. A non-branch instruction sequence of BF instructions assumes an instruction sequence from inst5 to inst8.

A state transition for branch prediction is illustrated in FIG. 4. This shows a state transition of a 1-bit saturation counter. The 1-bit saturation counter which has been widely used in the branch prediction, has states called “taken and untaken” as two states of 1 and 0 that can be expressed in one bit. It is of a saturation counter incremented when the result of branch is established and decremented when it is not established. When the counter assumes 1, i.e., a taken state, the branch is expected to be established. When the counter assumed 0, i.e., an untaken state, the branch is expected not to be established. A two-bit system is known as a system higher in prediction accuracy than the one-bit system. The art known per se can be applied to these prediction technologies.

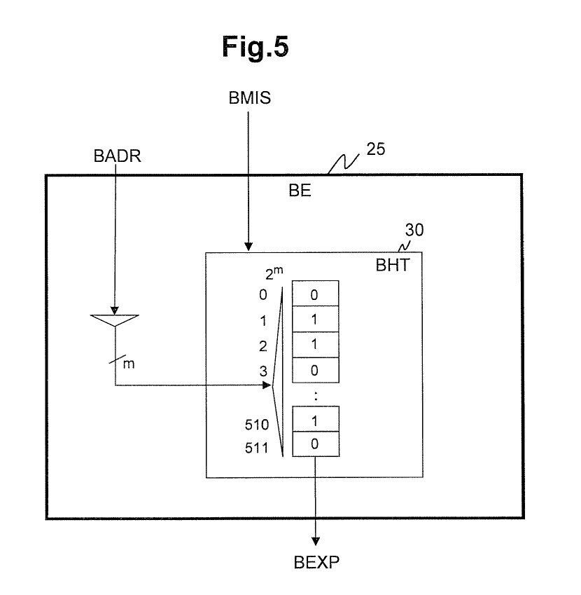

A configuration of the branch prediction unit (BE) 25 is conceptually shown in FIG. 5. The branch prediction unit 25 refers to a branch history table (BHT) 30 that holds the contents of branch prediction therein, using m bits corresponding to part of a branch source address BADR as an index address, and outputs a branch expectation result BEXP of a corresponding branch instruction. The contents of branch prediction are 1: taken and 0: untaken. In the branch history table (BHT) 30 referred to in the m bits corresponding to part of the branch source address BADR, the contents thereof are reversed and updated according to a branch prediction miss signal (BMIS). Incidentally, while various methods are known as the branch prediction method, other methods such as a two-level prediction method referring to a branch instruction and a global branch history, and a Gshare prediction method are also adaptable in the present invention if any method using the branch history table is adopted.

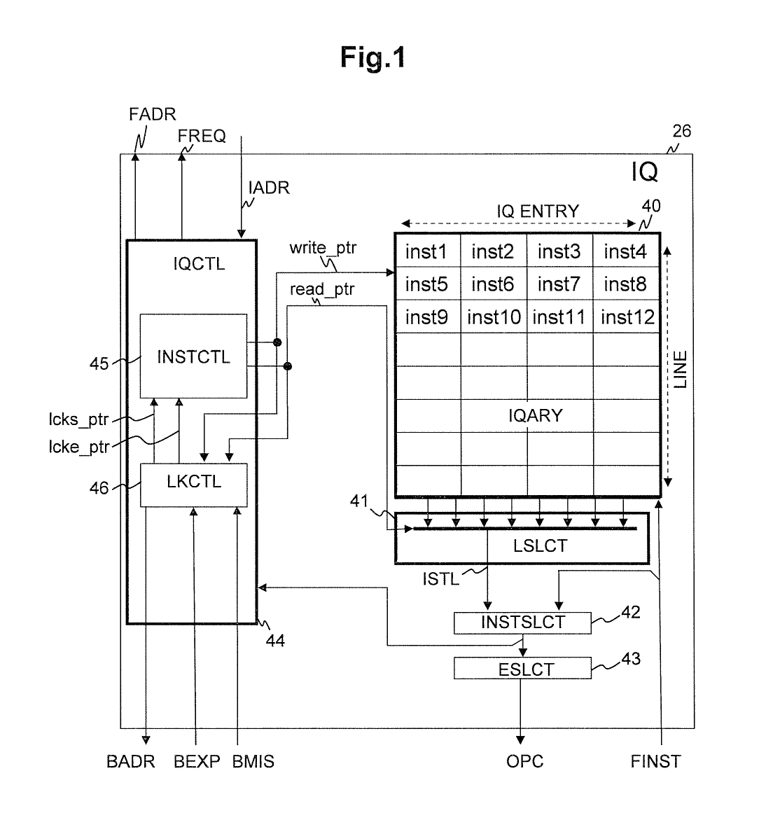

A configuration of the instruction queue 26 is illustrated in FIG. 1. The instruction queue 26 has an instruction queue array 40 used as a memory unit of 4 elements×8 lines, which holds instruction sequences therein. The reading of one line is selected from the eight lines by a line selector 41. An instruction corresponding to one line outputted from the queue line selector (LSLCT) 41 of the instruction queue or a fetch instruction FINST corresponding to one line supplied from the instruction cache 11 is selected by an instruction line selector (INSTSLCT) 42. An entry selector (ESLCT) 43 selects an instruction (OPC) of one entry from the instruction line selected by the instruction line selector 42 and outputs it to the instruction decoder 21.

The instruction queue 26 has an instruction queue controller (IQCTL) 44 used as a buffer controller. The instruction queue controller 44 is equipped with an instruction pointer controller (INSTCTL) 45 and an instruction queue lock controller (LKCTL) 46. The instruction pointer controller 45 controls a read pointer (read_ptr) indicative of the position of an instruction supplied to the instruction decoder 21, which is read from within the instruction queue array 40, and a write pointer (write_ptr) indicative of in which line lying within the instruction queue array 40 the fetch instruction FINST from the instruction cache 11 should be written. The instruction queue lock controller 46 controls a lock start pointer (lcks_ptr) used as a lock start position pointer of the instruction queue, and a lock end pointer (lcke_ptr) thereof used as a lock end position pointer. Further, the instruction queue lock controller 46 supplies the lock start pointer (lcks_ptr) and the lock end pointer (lcke_ptr) to the instruction pointer controller 45 to perform lock control on the instruction queue. While the control by the read pointer (read_ptr) and the write pointer (write_ptr) is based on FIFO (First-In First-Out), an entry between the lock start pointer (lcks_ptr) of the instruction queue and the lock end pointer (lcke_ptr) is sequentially repeated until a prediction miss occurs, so that it is read and pointed by the read pointer (read_ptr). More concrete contents of pointer control will be explained below.

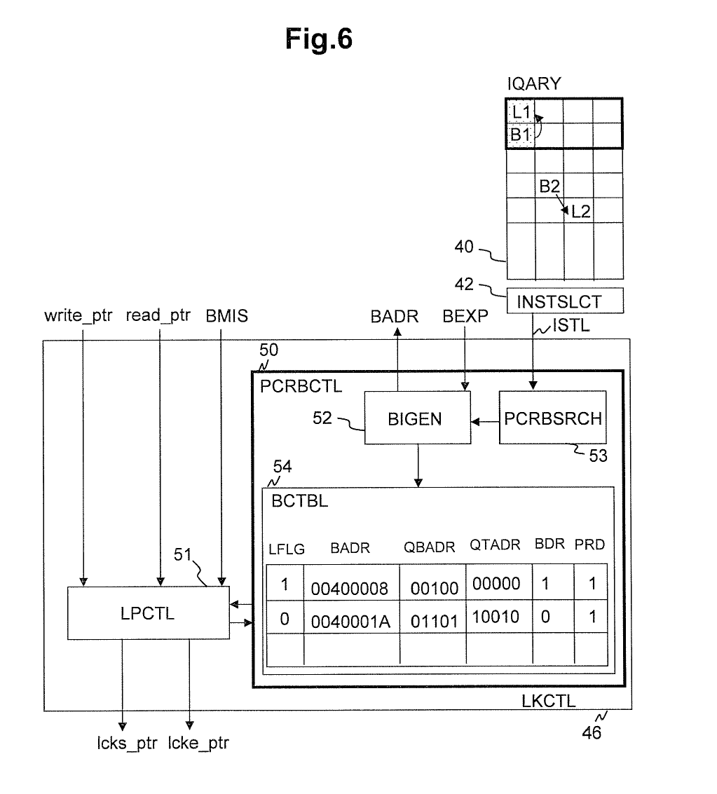

A configuration of the instruction queue lock controller (LKCTL) 46 is illustrated in FIG. 6. The instruction queue lock controller (LKCTL) 46 has a PC relative branch controller (PCRBCTL) 50 and a lock pointer controller (LPCTL) 51. The PC relative branch controller 50 is provided with a PC relative branch searcher (PCRBSRCH) 53, a branch information generator (BIGEN) 52 and a branch control table (BCTBL) 54. The PC relative branch searcher 53 inputs a selection instruction line ISTL outputted from the instruction line selector 42 of the instruction queue 26 and searches whether a PC relative branch instruction is contained in a sequence of instructions of the input line. The branch information generator (BIGEN) 52 generates branch information from the searched PC relative branch instruction and registers and manages the generated branch information in the branch control table 54. Information about a lock target flag (LFLG) indicative of whether being targeted for lock, a branch source address (BADR), an in-queue branch source address (QBADR), an in-queue branch target address (QBADR), a branch direction (BDR, 0: forward direction and 1: backward direction) and a branch prediction value (PRD, 0: untaken indicative of a non-branch prediction and 1: taken indicative of a branch prediction) are registered in the branch control table 54 according to need as information set every branch. Based on the information of the branch control table, the lock pointer controller 51 manages a lock start pointer (lcks_ptr) and a lock end pointer (lcke_ptr) as positions to be locked, of the instruction queue 26. In the branch control table 54, the lock target flag (LFLG) indicates whether being targeted for lock in the instruction queue at each branch. Assuming that when the branch source address (BADR) is H′ 00400008 and the two lines as viewed from the top of the instruction queue are used in the example of the single branch shown in FIG. 3, the instruction in-queue branch source address is brought to H′ 00100, the branch target address is brought to H′ 00000, the branch direction is brought to an address's opposite direction 1, and 1 (taken) is set as the branch prediction, the loop based on the single branch is a short loop in which instructions are held within the instruction queue 26. Therefore, the lock target flag (LFLG) is brought to 1. In the instruction queue array 40 shown in FIG. 6, L1 means the leading instruction (inst1 of FIG. 3) of the lock-target short loop, and B1 means the PC relative branch instruction (BF of FIG. 3) set as a base point of the short loop. The branch from B2 to L2 in FIG. 6 indicates a branch in the forward direction and belongs to neither the short loop nor the lock target. The lock pointer controller 51 acquires branch information targeted for lock from the branch control table 54 thereby to determine a locked spot and lock timing.

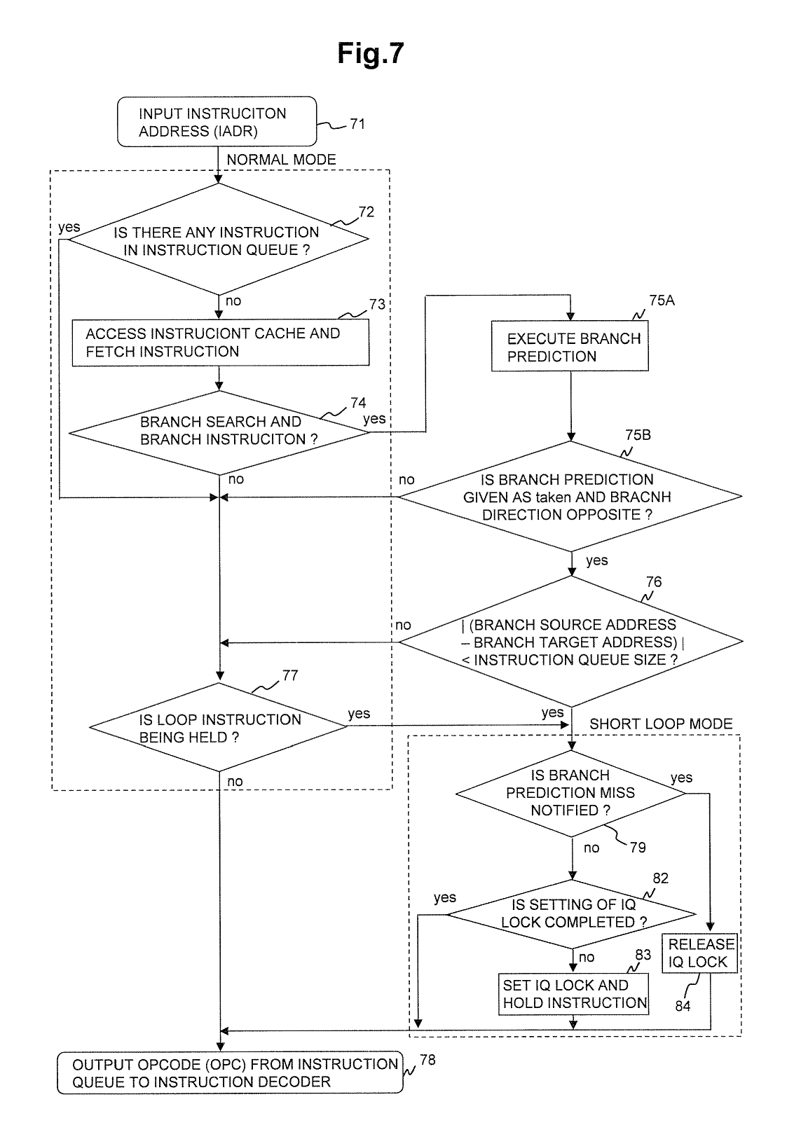

A control flow of the instruction queue is illustrated in FIG. 7. When an instruction address is supplied to the instruction queue 26 (71), the instruction queue 26 generates a fetch address (FADR) based on the input instruction address (IADR) if no instruction is supplied to the instruction queue 26 (72), and obtains access to the instruction cache 11 so that each instruction (FINST) corresponding to one line is supplied to the instruction queue 26 (73).

A branch search is carried out as determination as to whether a PC relative branch instruction is contained in an instruction line (ISTL) from the instruction cache 11, corresponding to the instruction address (IADR) (74). When no branch instruction exists and no loop instruction is held in the instruction queue 26 as a result of its branch search (77), an instruction OPC is selected by the entry selector (ESLCT) 43 subsequent to the instruction line selector 42 of the instruction queue 26 and outputted to the instruction decoder 21 (78). The above is taken as an operation in a normal mode.

When the PC relative branch instruction exists in the branch search (74), the branch prediction unit 25 performs a branch prediction using a branch source address (BADR) (75A), and the instruction queue 26 is inputted with the direction of branch prediction (BEXP) and holds a branch source address (BADR) for a branch instruction, an in-queue branch source address (QBADR), an in-queue branch target address (QTADR), a branch direction (BDR) and a branch prediction (PRD) in the branch control table 54. It is determined whether the branch prediction is indicative of taken and the branch direction is a decreasing address direction (the branch direction is opposite) (75B). When it is determined to do so, it is further determined whether the difference between the branch source address and the branch target address is smaller than the size of the instruction queue array 40 (76). When the difference is determined to be smaller than it, the control flow enters into a short loop mode. If it is larger than it, the control flow proceeds to the process 77 of the normal mode.

In the short loop mode, determinations are respectively made as to whether a branch prediction miss has been notified according to the signal BMIS (79) and whether the setting of IQ lock has been done (82). The setting of the IQ lock indicates whether the setting of lock for the instruction queue 26, i.e., the setting of the lock start pointer (lcks_ptr) and lock end pointer (lcke_ptr) of the instruction queue is being performed. If the setting of the IQ lock is not done without determination as to the branch prediction miss, the lock start pointer (lcks_ptr) and the lock end pointer (lcke_ptr) are set and each instruction necessary for a branch-based loop is held in the instruction queue 26 from the instruction cache 11 (83). Then, a necessary instruction OPC is selected by the instruction queue 26 and outputted to the instruction decoder 21 (78). When the branch prediction miss is notified at Step 79, a lock release for the instruction queue 26, i.e., the designation of the instruction queue by the lock start pointer (lcks_ptr) and lock end pointer (lcke_ptr) thereof is made invalid (84) and an instruction corresponding to an instruction address at that time is outputted to the instruction decoder 21 (78).

While at the instruction fetch in the instruction queue 26, the read pointer (read_ptr) indicates the position of an instruction address (IADR) on the instruction queue 26 and the short loop is repeated, the read pointer (read_ptr) indicates the proper location of the instruction queue 26, the selection of each instruction line (ISTL) and the supply of each instruction to the instruction decoder 21 are performed. In the instruction holding operation of Step 83 in the short loop mode, each instruction is held in the instruction queue 26. In the IQ lock setting operation of Step 83, reference is made to the branch control table 54, and the lock end pointer (lcke_ptr) is set to the in-queue branch source address QBADR and the lock start pointer (lcks_ptr) is set to the in-queue branch target address QBADR. When the short loop is of a single branch, i.e., the lock-target branch instruction is only one, the lock end pointer (lcke_ptr) and the lock start pointer (lcks_ptr) are uniquely determined. Using the write pointer (write_ptr), each instruction is sequentially held in the instruction queue 26 from the address specified by the lock start pointer (lcks_ptr) to the address specified by the lock end pointer (lcke_ptr). When the write pointer (write_ptr) becomes identical in value to the lock end pointer (lcke_ptr), the retention of a loop instruction is completed. When an address range is substantially designated by the lock end pointer (lcke_ptr) and the lock start pointer (lcks_ptr), access to the instruction cache 11 is inhibited. Each instruction for the loop is put into retention in a state in which the setting of the IQ lock has been performed in this way (77). Once after the IQ lock has been set, the instruction for the loop is placed into retention (yes of Step 77). The operation of supplying each instruction from the instruction queue 26 to the instruction decoder 21 in accordance with the set contents of the already set IQ lock is repeated in a range in which no branch miss occurs (no of Step 79). An instruction sequence designated by the lock end pointer (lcke_ptr) and lock start pointer (lcks_ptr) in the instruction queue 26 is repeatedly utilized. During that period, each instruction of the corresponding instruction sequence is not replaced with the instruction given from the instruction cache 11.

The timing at which the short loop mode is ended, is transferred from the executor of the CPU 22 as a branch prediction miss (BMIS). That is, when the branch prediction is missed (79), the IQ lock is released and a necessary instruction is supplied from the instruction queue 26 to the instruction decoder 21.

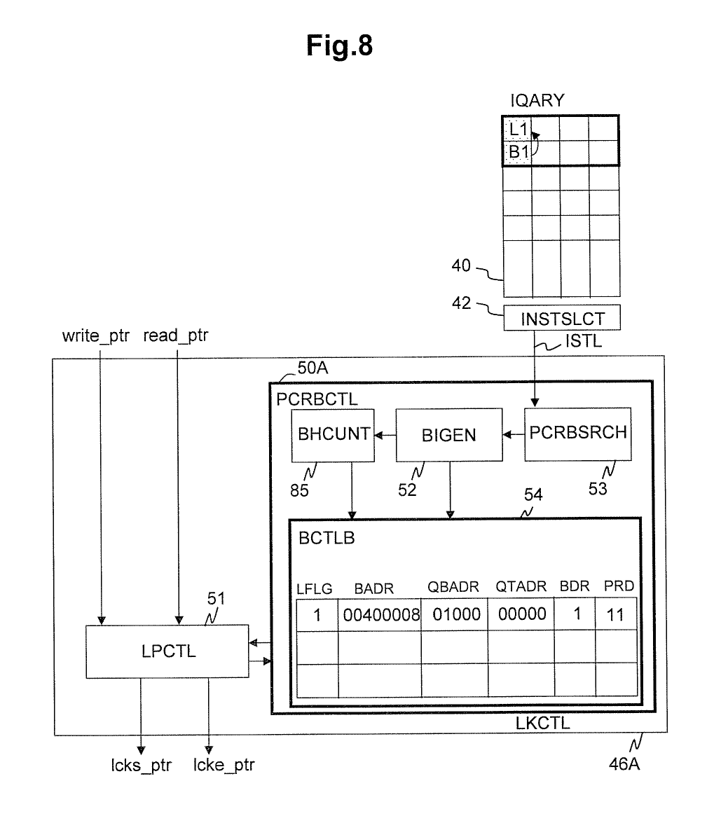

Another example of an instruction queue lock controller (LKCTL) is shown in FIG. 8. This is an example in which the branch prediction unit 25 shown in FIG. 2 is not provided. The present example is different from the above example in that a PC relative branch controller 50A of an instruction queue lock controller 46A makes a history of each loop branch thereby to perform substitution of a branch prediction. The point of difference therebetween will be explained. The PC relative branch controller 50A comprises, for example, a PC relative branch searcher 53, a branch information generator 52 which manages each searched PC relative branch instruction and generates branch information, a branch history counter 85 based on a loop branch and a branch control table 54. In the instruction queue lock controller 46A, each lock-target bit is set to 1 when the number of branches in a short loop exceeds a predetermined number at the branch history counter 85 (B′ 11 times in the example of FIG. 8) after the short loop has been found. The counting operation of the branch history counter 85 is as follows. Where a given branch source address is concerned, the branch information generator counts the number of branches when a branch direction is of an opposite direction (1) where a read pointer indicates the branch source address, and initializes a count value when the branch direction is of a forward direction (0) where the read pointer indicates the corresponding branch source address. A lock start pointer (lcks_ptr) and a lock end pointer (lcke_ptr) are set to the short loop in which a lock-target bit is set to 1, and the instruction queue is locked after instruction retention (IQ lock). When it breaks the loop, the lock-target bit is brought to 0, and the branch direction is brought to the forward direction or the read pointer (read_ptr) corresponding to an instruction address (IADR) falls out of an address range between the lock start pointer and the lock end pointer, whereby the lock of the instruction queue (IQ lock) is released. In the example of FIG. 6, the instruction queue lock is released by the branch prediction miss (BMIS), whereas in the example of FIG. 8, the branch direction is placed in the forward direction or the read pointer (read_ptr) differs from the lock address range (lcks_ptr to lcke₋ptr) so that the IQ lock is released.

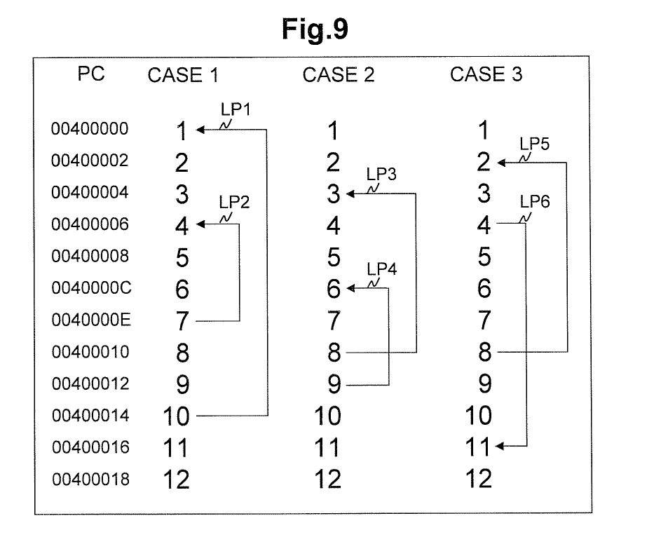

An example of a short loop including double branches is shown in FIG. 9. Multiple branches can be realized as extensions of these double branches. The double branches are classified into three cases. The case 1 shows where a branch source and a branch target of the other loop in double loops exist in one loop. A loop LP2 is repeated in a loop LP1. The case 2 shows where a branch target of another loop exists in one loop. A loop LP3 is repeated in a loop LP4. The case 3 shows where a branch source of another loop exists in one loop. A loop LP6 exits halfway through a loop LP5. A short loop lock mechanism adaptable to the three cases shown in FIG. 9 will be explained below.

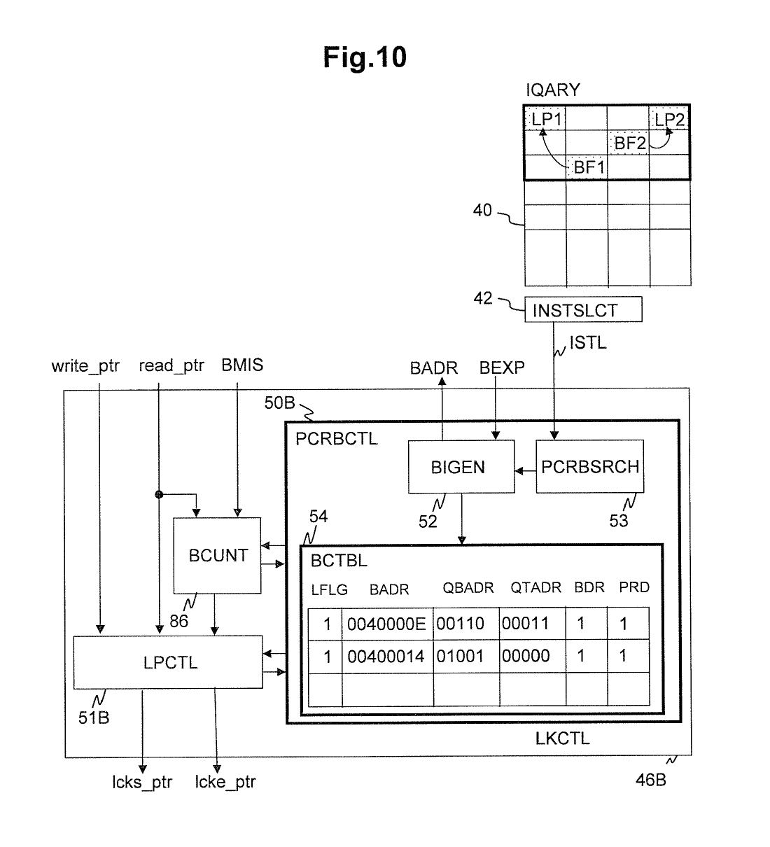

A further example of an instruction queue lock controller is shown in FIG. 10. An instruction queue lock controller 46B is different from FIG. 6 in that it has an in-lock branch counter (BLUNT) 86. A PC relative branch controller is illustrated as 50B and a lock pointer controller is illustrated as 51B. The PC relative branch controller 50B comprises a PC relative branch searcher 53, a branch information generator 52 which manages each searched PC relative branch instruction and generates branch information, and a branch control table 54. In a manner similar to the above, a branch source address (BADR), an in-queue branch source address (QBADR), an in-queue branch target address (QTADR), a branch direction (BDR) and a branch prediction value (PRD) are described in the branch control table 54 as information set every branch. The branch control table 54 has a lock target flag (LFLG) corresponding to information indicative of whether an instruction queue can be locked at each branch. The in-lock branch counter 86 inputs a read pointer (read_ptr), a branch miss (BMIS) and the information of the branch control table 54 of the PC relative branch controller 50B and counts the number of branches within a lock range. Based on the information of the branch control table 54, read pointer (read_ptr), write pointer (write_ptr) and count information of the in-lock branch counter 86, the lock pointer controller 51B manages a lock start pointer (lcks_ptr) and a lock end pointer (lcke_ptr) as positions to lock the instruction queue 26.

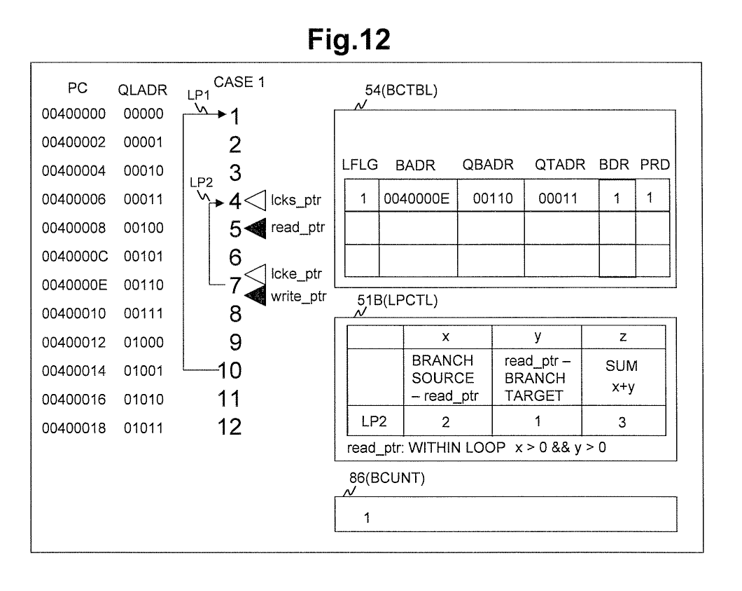

The operation of multiple branch-based instruction queue lock control by the instruction queue lock controller 46B of FIG. 10 is illustrated in each of FIGS. 12, 13 and 14. Each drawing shows, as one example, the case 1 of FIG. 9, i.e., the case in which another loop LP2 exists in the one loop LP1.

FIG. 12 shows a single branch case in which after the execution of instructions 1 through 3, instructions 4 through 7 are held in the corresponding instruction queue to assume a short loop mode and instructions 8 through 10 are never executed. QLADR is a local address (in-queue address) lying in the instruction queue 26. Since the instructions up to the instruction 7 are placed on the instruction queue, the write pointer (write_ptr) indicates the instruction 7. In FIG. 12, the instruction 5 specified by the read pointer (read_ptr) is supplied to the instruction decoder 21 as an opcode. A count value of the in-lock branch counter 86 is 1. The loop LP2 is registered in the branch control table 54 as a lock target. The lock pointer controller 51B first determines whether the read pointer (read_ptr) lies within the loop. That is, it is understood that since x (in-queue branch source address−read ptr)=2, y (read_ptr−in-queue branch target address)=1 and x>0 and y>0, the read pointer is placed within the loop LP2. At this time, the lock start pointer (lcks_ptr) is the instruction 4 and the lock end pointer (lcke_ptr) is the instruction 7. Namely, the lock pointer controller 51B controls the read pointer (read_ptr) so as to meet the conditions of x>0 and y>0 when the value of the in-lock branch counter 86 is 1, thereby making it possible to change the read pointer (read_{—} ptr) within the corresponding loop.

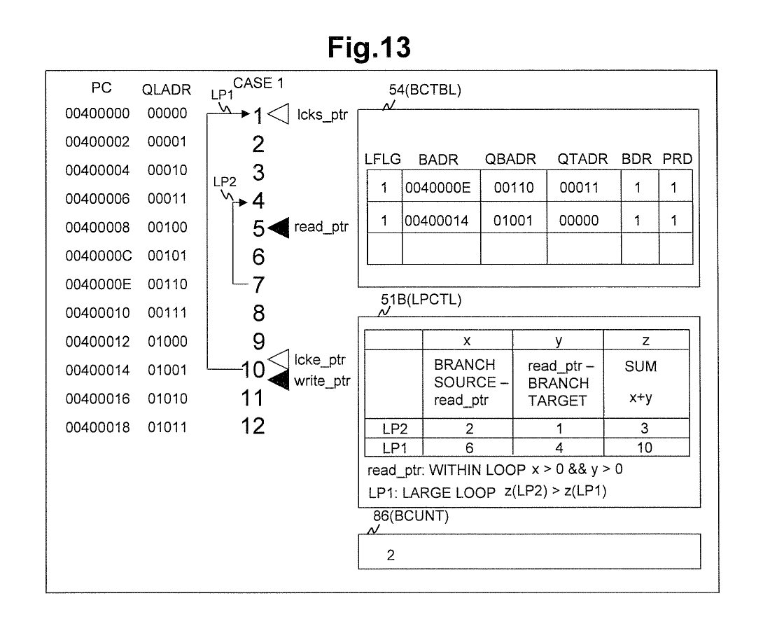

FIG. 13 shows a multiple branch case in which after instructions 1 through 10 are held in the instruction queue 26, a short loop mode is reached at instructions 4 through 7. Since the instructions up to the instruction 10 lie on the instruction queue 26, the write pointer (write_ptr) indicates the instruction 10, and the instruction 5 designated by the read pointer (read_ptr) is supplied to the instruction decoder 21 as an opcode in FIG. 13. A count value of the in-lock branch counter 86 is set to 2 corresponding to the number of branches in a lock range between the lock start pointer (lcks_ptr) and the lock end pointer (lcke_ptr). The two loops LP1 and LP2 are registered in the branch control table 54 as lock targets. The lock pointer controller 51B first determines whether the read pointer (read_ptr) is within the corresponding loop. It is understood that in the loop LP2, the read pointer (read_ptr) lies within the corresponding loop because x=2>0 and y=1>0, whereas in the loop LP1. the read pointer (read_ptr) lies within the corresponding loop because x=6>0 and y=4>0. Which loop is large is known from the magnitude of the sum z (=x+y) of x and y. Namely, which loop is large is known from z=3 in the loop LP2 and z=10 in the loop LP1. Comprehensive relationships of branch sources and targets between the loops are also understood by comparing x and y every loop. Since it is understood that the loop LP1 is a large loop from z here, the lock start pointer (lcks_ptr) and the lock end pointer (lcke_ptr) are respectively set so as to adapt to the instructions 1 and 10 in matching with the loop LP1 side.

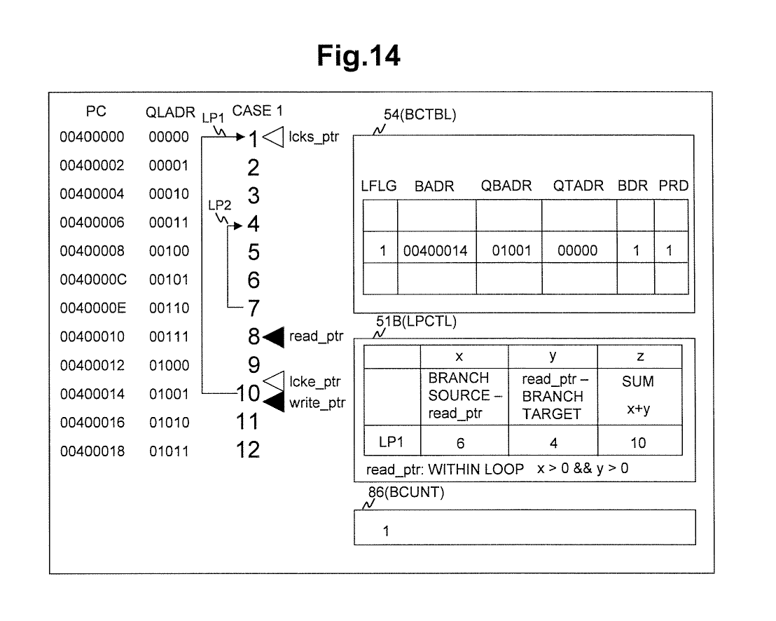

FIG. 14 shows a single branch case in which after instructions 1 through 10 are held in the instruction queue, the corresponding loop exits from the loop LP2 to assume a short loop mode. Since the instructions up to the instruction 10 lie on the instruction queue 26, the write pointer (write_ptr) indicates the instruction 10 and the instruction 8 specified by the read pointer (read_ptr) is supplied to the instruction decoder 21 as an opcode. Since the loop LP2 is deleted from the branch control table 54, only the loop LP1 is registered therein as a lock target. Since the loop in a lock range is only the loop LP1, the number of branches is 1 and the value of the in-lock branch counter 86 becomes 1. The lock pointer controller 51B determines whether the read pointer (read_ptr) lies within the loop. It is understood that since x=6, y=4 and x>0 and y>0, the read pointer (read_ptr) lies within the loop LP1. In the example of FIG. 14, the lock start pointer (lcks_ptr) indicates the instruction 1 and the lock end pointer (lcke_ptr) indicates the instruction 10.

As apparent from the examples of FIGS. 12 through 14, the values of the lock start pointer (lcks_ptr) and the lock end pointer (lcke_ptr) are dynamically moved in matching with the value of the in-lock branch counter 86 and the value of the read pointer (read_ptr). In which loop the read pointer (read_ptr) lies at present is discriminated from the values x and y. The comprehensive relationships of the branch sources and targets between the loops are also understood by comparing the magnitudes of x and y every loop. Further, the magnitudes of the loops in the multiple loops are discriminated from the magnitudes of the values x+y of the respective loops.

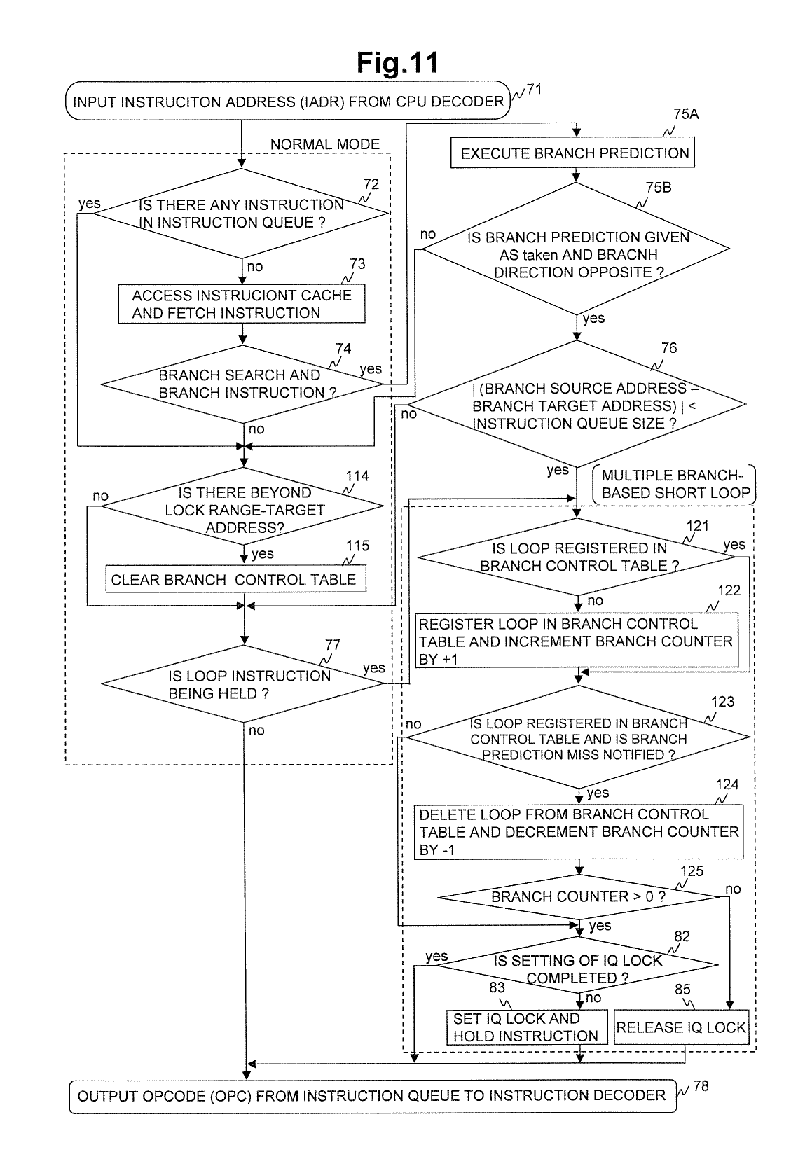

A flowchart for describing an instruction queue lock control operation that adapts to each of multiple branches is shown in FIG. 11. FIG. 11 is different from FIG. 7 in that a lock range-target address check (114, 115) and processes (121 through 125) of the branch control table 54 and the in-lock branch counter 86 are added to FIG. 7. The flow of FIG. 11 will be described with respect to the cases 1 through 3 of FIG. 9.

<<Case 1: Another loop LP2 exists in loop LP1>>

A description will first be made from the portion (instruction 8) that since the loop LP2 is registered in the corresponding branch control table and a branch miss occurs upon exiting from the corresponding loop after its lock, the loop LP2 is deleted from the branch control table 54 and the IQ lock related to the loop LP2 is released (85). The instructions 8, 9 and 11 are first executed. An instruction is fetched from the instruction cache 11 to the instruction queue 26 in the normal mode, and the corresponding instruction is selected and supplied to the instruction decoder 21.

At the instruction 10, the branch prediction is discriminated as taken, the branch direction is discriminated as a reverse direction (75B), and the difference between a branch source address and a branch target address is discriminated to be smaller than the corresponding instruction queue (76). Therefore, the control operation enters a multiple branch-based short loop mode. Since no loop is registered in the branch control table 54 (121), the corresponding instruction loop LP1 is registered in the branch control table 54 and the branch counter is brought to 1 (122). Consequently, the setting of a lock start pointer (lcks_ptr) and a lock end pointer (lcke_ptr) is performed as the process of setting the IQ lock (82 and 83). Instructions necessary for the branch-based loop have already been held in the instruction queue 26. At the instruction 7 again, the branch prediction is discriminated as taken, the branch direction is discriminated as the reverse direction (75B), the difference in address is discriminated to be smaller than the instruction queue (76), and the instruction queue lock control operation enters the multiple branch short loop mode. Then, the LP2 is registered in the branch control table 54 and the branch counter is brought to 2 (122). Here, the setting of the IQ lock is not changed (yes of Step 82). This is because it is not necessary to change the setting of the lock start pointer (lcks₋ptr) and the lock end pointer (lcke_ptr). An instruction necessary for instruction execution of the loop LP2 is supplied from the instruction queue 26 to the instruction decoder 21. The processing taken up to here corresponds to the case of FIG. 13, and the loop LP1 is brought to a lock range. If described accurately, FIG. 13 differs from FIG. 11 in that the instructions 8, 9 and 10 respectively assume states after having been held in the instruction queue 26, but the branch control table 54 and the lock pointer controller 51B are the same.

When a branch miss of the instruction 7 is notified after the loop is executed plural times in the loop LP2 (123), the loop LP2 is deleted from the branch control table 54 and the value of the branch counter is reduced (124) and brought to a value 1. Here, the setting of the IQ lock is not changed (yes of Step 82). This is because it is not necessary to change the setting of the lock start pointer (lcks_ptr) and the lock end pointer (lcke_ptr). When the instruction braches to the leading instruction 1 of the loop, an instruction for a loop 1 (LP1) is supplied from the instruction queue 26 to the instruction decoder 21 in accordance with the setting of the IQ lock. When a branch miss of the instruction 10 is notified after the loop is executed plural times in the loop LP1 (123), the loop LP1 is deleted from the branch control table 54 and the branch counter 86 is reduced and brought to a value 0 (125), so that the lock of the instruction queue is released (85). Upon exiting from the LP2, the branch control table 54 is changed and the value of the branch counter 86 is reduced. As in the case of FIG. 14, however, the instruction queue 26 remains locked at the portion of the loop LP1 and its lock is not released in this state. Namely, when the instruction loop registered in the branch control table 54 exists and the value of the branch counter 86 is not 0, the instruction queue 26 continues to be locked (125).

<<Case 2: Branch target of another loop LP4 exists in loop LP3>>

When only the loop LP3 is being executed, the loop is of a single branch. When the branch instruction 8 in the loop LP4 does not branch to the head of the loop LP3, the loop may be handled as a single branch. When the branch instruction 8 branches to the head of the loop LP3, the loop becomes a double branch. When the branch instruction 8 branches to the head of the loop LP3, the branch target of the loop LP4 differs from the case 1, but the case 2 may be set to the same flow as the case 1.

<<Case 3: Branch source of another loop LP6 exists in loop LP5>>

During execution of the loop LP5, a single branch is given where there is no branch in the loop LP6. A description will be made of a case in which when the instruction queue lock control operation enters a short loop mode at the loop LP5 and the instruction queue 26 is being locked, there are branches in the loop LP6. When the branch of the loop LP6 is given as untaken, the loop LP5 continues as a single-branch short loop. When the branch of the loop LP6 is given as taken, an out-of-address range (114) is reached at a lock range-target address check. Therefore, the branch control table is cleared (115), the instruction queue lock is released (85) and the branch instruction branches to the branch target of the loop LP6. A determination for the lock range address check can be made by x=branch source address−read_ptr<0 under lock pointer control.

While the invention made above by the present inventors has been described specifically on the basis of the preferred embodiments, the present invention is not limited to the embodiments referred to above. It is needless to say that various changes can be made thereto within the scope not departing from the gist thereof.

Control on an IQ lock at each of multiple loops above triple loops, for example, may also be performed similarly based on the contents described in FIGS. 11 through 14 in accordance with the value of the branch counter 86 and the like. An instruction prefetch may be performed on an instruction queue using an instruction prefetch mechanism in addition to the instruction fetch. The present invention is not limited to the SoC form, but may widely be applied to various data processors for general purposes and the like.

What is claimed is:

1. A data processor comprising:
an instruction fetch section for fetching an instruction;
an instruction decoder for decoding the instruction fetched by the instruction fetch section; and
an executor for executing the instruction, based on a result of decoding by the instruction decoder,
wherein the instruction fetch section comprises an instruction buffer and a branch prediction unit,
wherein the instruction buffer comprises a memory unit for storing each instruction fetched from outside and a buffer controller for controlling the memory unit, and
wherein when an execution history of a fetched condition branch instruction suggests condition establishment, and in the case that a branch direction of the fetched condition branch instruction corresponds to a direction opposite to the order of an instruction execution and a difference of instruction addresses from the branch source to the branch target based on the condition branch instruction is a range held in a storage capacity of the memory unit, the buffer controller retains, in the memory unit, an instruction sequence from a branch source to a branch target based on the condition branch instruction, supplies each instruction of the instruction sequence from the memory unit to the instruction decoder while an instruction execution of the instruction sequence retained therein is repeated, and releases retention of the instruction sequence when the instruction execution is exited from the instruction sequence.

2. The data processor according to claim 1, wherein the buffer controller performs control of a read pointer and a write pointer based on an FIFO (first-in first-out) form on the memory unit, specifies the instruction sequence retained in the memory unit by a lock start pointer and a lock end pointer, and changes the read pointer in a range designated by the lock start pointer and the lock end pointer while the instruction execution of the instruction sequence is repeated.

3. The data processor according to claim 2, wherein the buffer controller performs pointer control using a branch control table in which an instruction address for the condition branch instruction and in-buffer addresses of the memory unit holding the condition branch instruction and a branch target instruction based thereon respectively are registered.

4. The data processor according to claim 3, wherein when each of condition branch instructions is contained in the instruction fetched into the memory unit, the buffer controller registers information about the instruction sequence of the condition branch instructions in the branch control table.

5. The data processor according to claim 1, wherein the condition branch instruction is a PC relative condition branch instruction.

6. The data processor according to claim 1,
wherein the instruction fetch section comprises a branch prediction unit for performing a branch prediction, based on the execution history of the condition branch instruction,
wherein the branch prediction unit performs a branch prediction, based on the instruction address for the condition branch instruction and outputs a result of the prediction therefrom, and
wherein the buffer controller determines based on the result of prediction whether the condition establishment of the condition branch instruction is suggested.

7. The data processor according to claim 1, wherein the buffer controller comprises a branch history counter for counting the number of repetitive executions of the instruction sequence from the branch source to the branch target based on the condition branch instruction with a branch direction being placed in a direction opposite to an instruction address layout, and determines that the formation of a short loop is suggested, by a counted value of the branch history counter exceeding a predetermined value.

8. The data processor according to claim 2,
wherein the buffer controller comprises a branch counter indicative of a multiple number of loops each formed by the instruction sequence from the branch source to the branch target based on the condition branch instruction, and
wherein when the loop is a single loop, the buffer controller determines the values of the lock start pointer and the lock end pointer in association with a branch target address and a branch source address of the single loop, and when the loop is multiple loops, the buffer controller determines the values of the lock start pointer and the lock end pointer in association with a branch target and a branch source address of the largest loop.

9. The data processor according to claim 8, wherein the buffer controller acquires, every loop, first data corresponding to a difference in address of a read pointer relative to the branch source on the memory unit, second data corresponding to a difference in address of a branch target relative to a read pointer on the memory unit and third data corresponding to the sum of the first data and the second data, determined, by assuming the first and second data to be positive integer values respectively, whether the corresponding read pointer is within its own loop, discriminates comprehensive relationships of the branch sources in the multiple loops, based on the magnitude of the first data for said each loop, and discriminates a relationship between the magnitudes of the loops in the multiple loops, based on the magnitude of the third data for each loop.

10. The data processor according to claim 1, further comprising an instruction cache memory,
wherein the instruction fetch section fetches a necessary instruction from the instruction cache memory.

11. A data processing system comprising:
a data processor according to claim 10; and
an external memory coupled to the data processor,
wherein the instruction cache memory holds some of instructions retained in the external memory to perform an associative memory operation.
